(19) United States
(12) Patent Application Publication
(10) Pub. No.: US 2026/0302294 A1
(43) Pub. Date: Oct. 1, 2026

(54) FUEL CELL SYSTEM AND CONTROL METHOD THEREOF

(71) Applicant: HONDA MOTOR CO., LTD., Tokyo (JP)

(72) Inventors: Tetsu YOSHIKAWA, Saitama (JP); Tsubasa NISHIOKA, Saitama (JP)

(21) Appl. No.: 19/558,490

(22) Filed: Mar. 6, 2026

(30) Foreign Application Priority Data
Mar. 31, 2025 (JP) 2025-058164

(51) Int. Cl. H01M 8/04746; H01M 8/04225; H01M 8/04228; H01M 8/04302; H01M 8/04303; H01M 8/0438

(52) U.S. Cl. CPC H01M 8/04753; H01M 8/04225; H01M 8/04228; H01M 8/04302; H01M 8/04303; H01M 8/04388

(57) ABSTRACT

A fuel cell system includes an ECU that operates a cathode gas supplier and an anode gas supplier. The ECU is configured to perform a power generation shutdown process for closing cathode seal valves at a power generation shutdown, and then stopping supply of anode gas and closing a purge valve in a state in which an anode pressure is higher than a cathode pressure, and a fuel supply process for supplying, when a predetermined start condition is satisfied after the completion of the power generation shutdown process, anode gas until the anode pressure reaches a predetermined completion determination pressure. After the fuel supply process is started, when the range of fluctuation of the anode pressure over a predetermined time is equal to or smaller than a predetermined completion determination range, the ECU terminates the fuel supply process even if the anode pressure is lower than the completion determination pressure.

This application is based on and claims the benefit of priority from Japanese Patent Application No. 2025-058164, filed on Mar. 31, 2025, the content of which is incorporated herein by reference.

### BACKGROUND OF THE INVENTION

### Field of the Invention

The present invention relates to a fuel cell system and a control method thereof.

### Related Art

In recent years, research and development on fuel cells that contribute to energy efficiency has been conducted to ensure that more people have access to affordable, reliable, sustainable, and advanced energy.

In many recent fuel cell systems, in order to suppress deterioration of a fuel cell (specifically, an electrolyte membrane, an anode electrode, a cathode electrode, and the like), the deterioration resulting from an increase in cathode potential during soak of the fuel cell, a fuel supply process is periodically performed to supply anode gas (hydrogen gas) to the fuel cell during the soak, so that the hydrogen partial pressure of the anode electrode during the soak is kept at a predetermined pressure or higher (see, for example, Japanese Unexamined Patent Application, Publication No. 2009-117056).

Patent Document 1: Japanese Unexamined Patent Application, Publication No. 2009-117056

### SUMMARY OF THE INVENTION

In the invention described in Japanese Unexamined Patent Application, Publication No. 2009-117056, the remaining amount of anode gas to be supplied to the fuel cell during soak is not sufficiently considered. Specifically, in many fuel cell systems, anode gas stored in a high-pressure tank is supplied to a fuel cell. However, in the invention described in Japanese Unexamined Patent Application, Publication No. 2009-117056, the amount of anode gas to be supplied is not sufficiently considered when the remaining amount of anode gas is small in the high-pressure tank.

An object of the present invention is to obtain a fuel cell system that can suppress deterioration of a fuel cell resulting from an increase in cathode potential during soak, even if the remaining amount of anode gas is small, thereby contributing to higher energy efficiency.
(1) A fuel cell system according to the present invention (e.g., a fuel cell system 1 described later) includes: a fuel cell (e.g., a fuel cell stack 2 described later) that generates power when receiving anode gas and cathode gas; a cathode gas supplier (e.g., a cathode gas supplier 4 described later) that supplies cathode gas to a cathode flow path (e.g., a cathode flow path 22 described later) of the fuel cell; an anode gas supplier (e.g., an anode gas supplier 3 described later) that supplies anode gas to an anode flow path (e.g., an anode flow path 21 described later) of the fuel cell; and a controller (e.g., an ECU 6 described later) that operates the cathode gas supplier and the anode gas supplier, the cathode gas supplier including cathode seal valves (e.g., an inlet seal valve 421 and an outlet seal valve 431 described later) provided on the inlet side and the outlet side of the cathode flow path, the anode gas supplier including an anode discharge valve (e.g., a purge valve 332 described later) provided on the outlet side of the anode flow path, the controller being configured to perform a shutdown process (e.g., a power generation shutdown process described later) for closing the cathode seal valves at the power generation shutdown of the fuel cell, and then stopping supply of anode gas to the fuel cell and closing the anode discharge valve in a state in which the fuel cell has an anode pressure higher than a cathode pressure, and a fuel supply process (e.g., a fuel supply process described later) for supplying, when a predetermined start condition is satisfied after the completion of the shutdown process, anode gas to the fuel cell until the anode pressure reaches a predetermined completion determination pressure, the controller terminating the fuel supply process even if the anode pressure is lower than the completion determination pressure when the range of fluctuation of the anode pressure over a predetermined time is equal to or smaller than a predetermined completion determination range after the start of the fuel supply process.
(2) In this case, it is preferable that the anode gas supplier includes: an anode gas supply source (e.g., a hydrogen tank 31 described later), an anode gas supply path (e.g., hydrogen supply pipe 32 described later) connecting the anode gas supply source and the inlet side of the anode flow path, an injector (e.g., an injector 322 described later) provided on the anode gas supply path, and an anode gas return path (e.g., a hydrogen return pipe 34 described later) connecting the outlet side of the anode flow path and the downstream side of the injector on the anode gas supply path, wherein the controller acquires, as the anode pressure, a pressure detected by a first pressure detector (e.g., an anode pressure sensor 28 described later) provided between the injector and the fuel cell on the anode gas supply path.
(3) In this case, it is preferable that when the fuel supply process is terminated before the anode pressure reaches the completion determination pressure, the controller prohibits a subsequent fuel supply process and notifies a user that a remaining amount of anode gas is insufficient in the anode gas supply source.
(4) In this case, it is preferable that the controller starts the fuel supply process on the start condition that a predetermined time has elapsed from the completion of the shutdown process.
(5) In this case, it is preferable that the controller starts the fuel supply process on the start condition that the anode pressure is reduced by a predetermined pressure from the completion of the shutdown process.
(6) In this case, it is preferable that the anode gas supplier further includes a pressure reducing valve (e.g., a pressure reducing valve 324 described later) provided between the injector and the anode gas supply source on the anode gas supply path, and the controller prohibits the subsequent fuel supply process when a pressure detected by a second pressure detector provided between the anode gas supply source and the pressure reducing valve is lower than a predetermined prohibition determination pressure at the completion of the fuel supply process.
(7) A control method of a fuel cell system according to the present invention includes a first step of closing cathode seal valves at shutdown of a fuel cell, and then stopping supply of anode gas to the fuel cell and closing an anode discharge valve in a state in which the fuel cell has an anode pressure higher than a cathode pressure, and a second step of supplying, when a predetermined start condition is satisfied after completion of the first step, anode gas to the fuel cell until the anode pressure reaches a predetermined completion determination pressure, wherein the second step is terminated even if the anode pressure is lower than the completion determination pressure when the range of fluctuation of the anode pressure over a predetermined time is equal to or smaller than a predetermined completion determination range after the start of the second step.
(1) At the shutdown of the power generation of the fuel cell, the controller performs the power generation shutdown process in which the cathode seal valve is closed, and then the supply of anode gas to the fuel cell is stopped and the anode discharge valve is closed in a state in which the anode pressure of the fuel cell is higher than the cathode pressure. Furthermore, if the predetermined start condition is satisfied after the completion of the shutdown process, the controller performs the fuel supply process in which anode gas is supplied to the fuel cell until the anode pressure reaches the predetermined completion determination pressure. Thus, the hydrogen partial pressure in the anode electrode of the fuel cell during soak can be kept at a predetermined pressure or higher, thereby reducing the deterioration of the fuel cell, the deterioration being caused by an increase in cathode potential during soak of the fuel cell. After the fuel supply process is started, when the range of fluctuation of the anode pressure over the predetermined time is equal to or smaller than the predetermined completion determination range, the controller terminates the ongoing fuel supply process even if the anode pressure is lower than the completion determination pressure. Thus, according to the present invention, even if the remaining amount of anode gas is insufficient at the start of the fuel supply process as described above, the remaining anode gas can be supplied to the fuel cell as much as possible. This can minimize deterioration of the fuel cell and contribute to higher energy efficiency, the deterioration being caused by an increase in cathode potential during soak.
(2) The controller acquires, as an anode pressure, a pressure detected by the first pressure detector provided on the fuel cell side relative to the injector on the anode gas supply path connecting the anode gas supply source and the inlet side of the anode flow path. As described above, in the present invention, the timing for terminating the fuel supply process is determined on the basis of the range of fluctuation of a pressure on the low-pressure side of the injector on the anode gas supply path reaching the fuel cell on the low-pressure side from the anode gas supply source on the high-pressure side. Thus, even when the remaining amount of anode gas is insufficient in the anode gas supply source, the remaining anode gas is supplied to the fuel cell as much as possible, thereby minimizing the deterioration of the fuel cell.
(3) If the fuel supply process is terminated before the anode pressure reaches the completion determination pressure, in other words, if the fuel supply process is terminated because the remaining amount of anode gas is insufficient in the anode gas supply source, the controller prohibits the subsequent fuel supply process and notifies the user that the remaining amount of anode gas is insufficient in the anode gas supply source. Thus, for the subsequent start of the fuel cell system, the consumption of anode gas can be minimized in the fuel cell during soak as much as possible, and the user can recognize that the remaining amount of anode gas is insufficient.
(4) The controller starts the fuel supply process on the start condition that a predetermined time has elapsed from the completion of the shutdown process. In other words, when a predetermined time has elapsed from the completion of the shutdown process, the controller starts the fuel supply process regardless of the remaining amount of anode gas at that time. Thus, according to the present invention, anode gas can be supplied to the fuel cell as much as possible even if the remaining amount of anode gas is insufficient, thereby minimizing the deterioration of the fuel cell, the deterioration being caused by an increase in cathode potential during soak.
(5) The controller starts the fuel supply process on the start condition that the anode pressure is reduced by a predetermined pressure from the completion of the shutdown process. In other words, if the anode pressure is reduced by the predetermined pressure from the completion of the shutdown process, the controller starts the fuel supply process regardless of the remaining amount of anode gas at that time. Thus, according to the present invention, anode gas can be supplied to the fuel cell as much as possible even if the remaining amount of anode gas is insufficient, thereby minimizing the deterioration of the fuel cell, the deterioration being caused by an increase in cathode potential during soak.
(6) At the completion of the fuel supply process, the controller prohibits the execution of the subsequent fuel supply process when a pressure detected by the second pressure detector provided between the anode gas supply source and the pressure reducing valve on the anode gas supply path is lower than the predetermined prohibition determination pressure. This can prevent an excessive reduction in pressure in the anode gas supply source during soak, thereby protecting the anode gas supply source.
(7) According to the control method of the fuel cell system of the present invention, even if the remaining amount of anode gas is insufficient during soak, the remaining anode gas can be supplied to the fuel cell. This can minimize deterioration of the fuel cell as much as possible and contribute to higher energy efficiency, the deterioration being caused by an increase in cathode potential during soak.

### BRIEF DESCRIPTION OF THE DRAWINGS

FIG. 1 shows the configuration of a fuel cell system according to a first embodiment of the present invention;

FIG. 2 is a flowchart showing the specific steps of a power generation shutdown process;

FIG. 3A is a flowchart showing the specific steps of an anode gas filling process (1);

FIG. 3B is a flowchart showing the specific steps of the anode gas filling process (2);

FIG. 4A is a time chart showing a first example of a change of an anode pressure, the change being made by the power generation shutdown process and the anode gas filling process;

FIG. 4B is a time chart showing a second example of a change of an anode pressure, the change being obtained by the power generation shutdown process and the anode gas filling process;

FIG. 5 is a part of a flowchart showing the specific steps of an anode gas filling process in a fuel cell system according to a second embodiment of the present invention;

FIG. 6 is a part of a flowchart showing the specific steps of an anode gas filling process in a fuel cell system according to a third embodiment of the present invention; and

FIG. 7 is a part of a flowchart showing the specific steps of an anode gas filling process in a fuel cell system according to a fourth embodiment of the present invention.

### DETAILED DESCRIPTION OF THE INVENTION

### First Embodiment

A fuel cell system according to a first embodiment of the present invention will be described below with reference to the accompanying drawings.

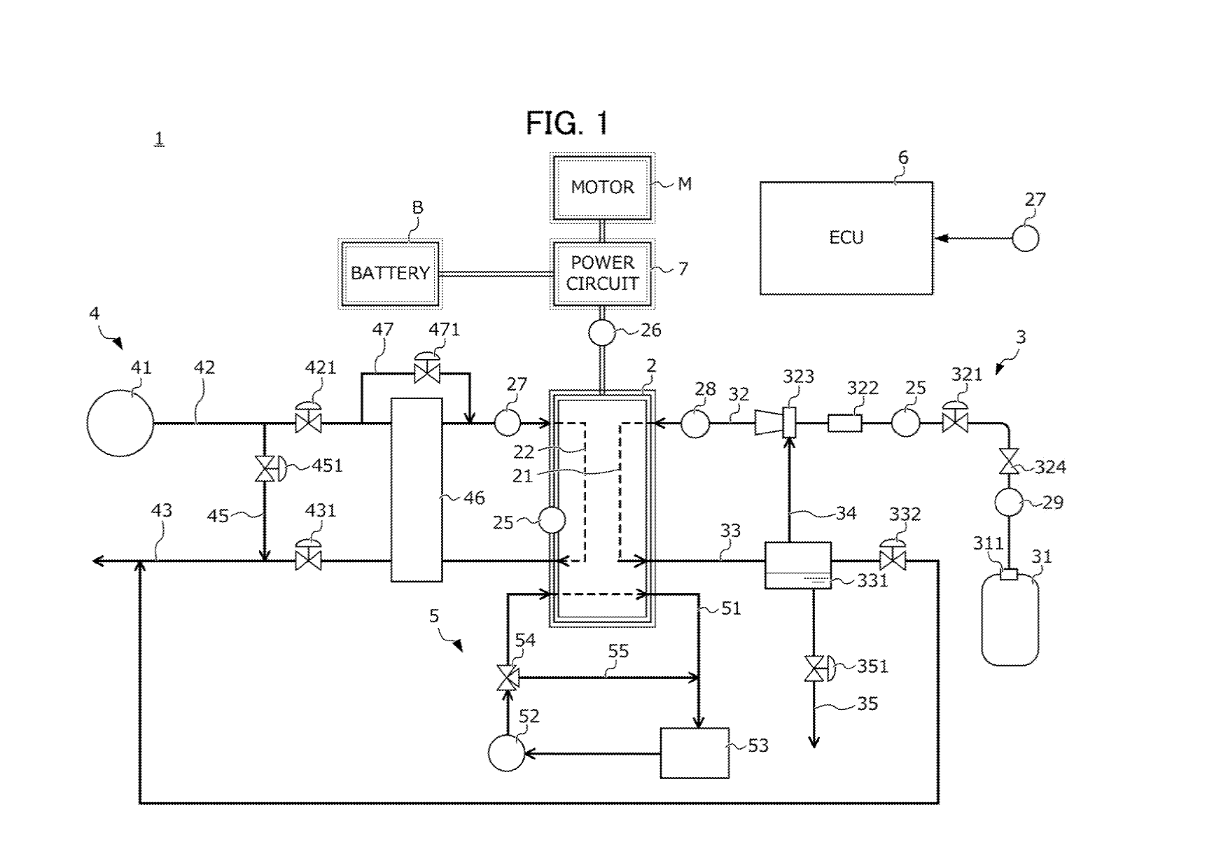

FIG. 1 shows the configuration of a fuel cell system 1 according to the present embodiment. The fuel cell system 1 includes a fuel cell stack 2 that generates power when receiving anode gas and cathode gas, an anode gas supplier 3 that supplies hydrogen as anode gas to an anode flow path 21 of the fuel cell stack 2, a cathode gas supplier 4 that supplies air as cathode gas to a cathode flow path 22 of the fuel cell stack 2, a cooling system 5 that cools the fuel cell stack 2, a battery B that stores power generated by the fuel cell stack 2, a drive motor M that rotates tires (not shown) using power supplied from the fuel cell stack 2 and the battery B, a power circuit 7 that electrically connects the battery B, the drive motor M, and the fuel cell stack 2, and an ECU 6 that is a computer for controlling these components. Hereinafter, the fuel cell system 1 is installed in a fuel cell vehicle that travels with the tires serving as driving wheels.

For example, the fuel cell stack 2 is a stack structure in which several tens to several hundreds of fuel battery cells are stacked. Each of the fuel battery cells is configured such that a membrane electrode assembly (MEA) is held between a pair of separators. The membrane electrode assembly is composed of two electrodes: an anode electrode (anode) and a cathode electrode (cathode), and a solid polymer electrolyte membrane held between the electrodes. Typically, the electrodes are each formed from a catalyst layer that undergoes an oxidation/reduction reaction in contact with the solid polymer electrolyte membrane, and a gas diffusion layer in contact with the catalyst layer. When hydrogen is supplied to the anode flow path 21 formed near the anode electrode and air containing oxygen is supplied to the cathode flow path 22 formed near the cathode electrode, the fuel cell stack 2 generates power using an electrochemical reaction of hydrogen and oxygen. The power generated by the fuel cell stack 2 is supplied to the drive motor M, the battery B, and the like as loads via the power circuit 7.

The anode gas supplier 3 includes a hydrogen tank 31 that stores hydrogen gas with a high pressure, a hydrogen supply pipe 32 extending from the hydrogen tank 31 to the inlet side of the anode flow path 21 of the fuel cell stack 2, a hydrogen discharge pipe 33 extending from the outlet side of the anode flow path 21 to a diluter (not shown) provided in the cathode gas supplier 4, and a hydrogen return pipe 34 that branches from the hydrogen discharge pipe 33 and extends to the hydrogen supply pipe 32.

The hydrogen supply pipe 32 is a pipe that connects the hydrogen tank 31 and the inlet side of the anode flow path 21 and guides, as anode gas, high-pressure hydrogen gas stored in the hydrogen tank 31 to the anode flow path 21. The hydrogen supply pipe 32 includes a pressure reducing valve 324, a shutoff valve 321, an injector 322, and an ejector 323 in this order from the hydrogen tank 31 on the high-pressure side to the fuel cell stack 2 on the low-pressure side.

The hydrogen tank 31 includes a tank valve 311 that opens or closes in response to a command signal from the ECU 6. The hydrogen tank 31 is connected to the hydrogen supply pipe 32 via the tank valve 311. The pressure reducing valve 324 reduces the pressure of hydrogen gas, which is supplied from the hydrogen tank 31, to a predetermined pressure. The shutoff valve 321 is a solenoid valve that opens or closes in response to a command signal from the ECU 6. The injector 322 is a solenoid valve that opens or closes in response to a command signal from the ECU 6. When the injector 322 is opened, high-pressure hydrogen gas supplied though the shutoff valve 321 is injected into the ejector 323. The amount of injected hydrogen gas from the injector 322 is controlled under PWM control by the ECU 6. The ejector 323 mixes hydrogen gas injected from the injector 322 and anode off-gas (that is, hydrogen-containing gas discharged from the outlet side of the anode flow path 21) discharged from the hydrogen return pipe 34, and ejects the mixed gas to the inlet side of the anode flow path 21. Thus, in the anode gas supplier 3 configured thus, the injector 322 is opened or closed while both of the tank valve 311 and the shutoff valve 321 are opened, so that hydrogen gas stored in the hydrogen tank 31 can be supplied to the fuel cell stack 2.

The hydrogen return pipe 34 is a pipe that connects the hydrogen discharge pipe 33 connected to the outlet side of the anode flow path 21 and the ejector 323 provided downstream of the injector 322 on the hydrogen supply pipe 32 and guides, to the ejector 323, part of anode off-gas passing through the hydrogen discharge pipe 33. This allows anode off-gas containing hydrogen to circulate through a circulating flow path with anode gas additionally injected from the injector 322, the circulating flow path including the hydrogen supply pipe 32, the anode flow path 21, the hydrogen discharge pipe 33, the hydrogen return pipe 34, and the ejector 323.

The hydrogen discharge pipe 33 is a pipe connecting the outlet side of the anode flow path 21 and the diluter (not shown) of the cathode gas supplier 4. The hydrogen discharge pipe 33 includes, sequentially from the fuel cell stack 2 to the cathode gas supplier 4, a catch tank 331 that stores water contained in anode off-gas, and a purge valve 332 that discharges anode off-gas to the cathode gas supplier 4. Furthermore, the catch tank 331 has a drain pipe 35 for discharging stored water. The drain pipe 35 reaches the downstream side of the purge valve 332 on the hydrogen discharge pipe 33 from the catch tank 331. The drain pipe 35 has a drain valve 351. When the drain valve 351 is opened, water stored in the catch tank 331 is discharged to the diluter (not shown) through the hydrogen discharge pipe 33. The purge valve 332 and the drain valve 351 are solenoid valves that open or close in response to a command signal from the ECU 6.

The cathode gas supplier 4 includes an air compressor 41, an air supply pipe 42 extending from the air compressor 41 to the inlet portion of the cathode flow path 22, an air discharge pipe 43 extending from the discharge portion of the cathode flow path 22 to the diluter (not shown), an air bypass pipe 45 that branches from the air discharge pipe 43 and extends to the air supply pipe 42, and a humidifier 46 connecting the air discharge pipe 43 and the air supply pipe 42.

The air compressor 41 supplies outside air to the cathode flow path 22 of the fuel cell stack 2 through the air supply pipe 42. The air compressor 41 operates in response to a command signal from the ECU 6. The humidifier 46 recovers water contained in gas discharged from the cathode flow path 22 (hereinafter also referred to as "cathode off-gas") and uses the recovered water to humidify air supplied from the air compressor 41. With the function of the humidifier 46, the MEA of the fuel cell stack 2 during power generation is kept in a moist state suitable for power generation.

The air supply pipe 42 includes a humidifier bypass pipe 47 that bypasses the humidifier 46. The humidifier bypass pipe 47 has a bypass valve 471. When the bypass valve 471 is opened, air supplied from the air compressor 41 mostly bypasses the humidifier 46 and is supplied to the fuel cell stack 2. The bypass valve 471 is a solenoid valve that opens or closes in response to a command signal from the ECU 6.

In addition, the air supply pipe 42 and the air discharge pipe 43 include an inlet seal valve 421 and an outlet seal valve 431, respectively. When the seal valves 421 and 431 are closed, the inside of the cathode flow path 22 is isolated from the outside air. The seal valves 421 and 431 are solenoid valves that open or close in response to a command signal from the ECU 6.

The air bypass pipe 45 is a pipe connecting the air supply pipe 42 on the high-pressure side and the air discharge pipe 43 on the low-pressure side. More specifically, the air bypass pipe 45 connects the upstream side of the humidifier 46 and the inlet seal valve 421 on the air supply pipe 42 and the downstream side of the humidifier 46 and the outlet seal valve 431 on the air discharge pipe 43. Thus, air supplied from the air compressor 41 partly bypasses the humidifier 46 and the cathode flow path 22 and is supplied to the air discharge pipe 43 through the air bypass pipe 45.

The air bypass pipe 45 has a back-pressure control valve 451 for adjusting the back pressure of the cathode flow path 22 of the fuel cell stack 2. The back-pressure control valve 451 is a solenoid valve that opens or closes in response to a command signal from the ECU 6.

The cooling system 5 includes a refrigerant circulating path 51 that includes the inside of the fuel cell stack 2 as a part of the flow path, a cooling pump 52 that circulates a refrigerant in the refrigerant circulating path 51, a radiator 53 provided upstream of the cooling pump 52 on the refrigerant circulating path 51, a thermo valve 54 provided downstream of the cooling pump 52 on the refrigerant circulating path 51, and a bypass pipe 55 connecting the thermo valve 54 and the upstream side of the radiator 53 on the refrigerant circulating path 51.

The fuel cell stack 2 is cooled by heat exchange with the refrigerant passing through the flow path in the fuel cell stack 2. The radiator 53 cools the refrigerant by heat exchange with the outside air. The cooling pump 52 operates in response to a command signal from the ECU 6. The rotational speed of the cooling pump 52 is controlled by the ECU 6. As the rotational speed of the cooling pump 52 is increased, the quantity of the refrigerant circulating in the refrigerant circulating path 51 increases, the refrigerant flow path including the fuel cell stack 2 and radiator 53. This can improve the cooling capacity of the fuel cell stack 2.

The thermo valve 54 is a cross valve that opens or closes in response to a command signal from the ECU 6. The opening ratio of the thermo valve 54 (the ratio of the opening near the refrigerant circulating path 51 (100 to 0%) to the opening near the bypass pipe 55 (0 to 100%)) is controlled by the ECU 6. When the opening ratio of the thermo valve 54 is maximized (that is, "1"), the refrigerant discharged from the cooling pump 52 is fully supplied to the fuel cell stack 2. This can improve the cooling capacity of the fuel cell stack 2. When the opening ratio of the thermo valve 54 is minimized (that is, "0"), the refrigerant discharged from the cooling pump 52 is fully supplied to the bypass pipe 55.

The battery B is a secondary cell capable of discharging for converting chemical energy into electric energy and charging for converting electric energy into chemical energy. In the following, the battery B is a so-called lithium ion storage battery that is charged and discharged by the movement of lithium ions between electrodes. The present invention is not limited thereto. The battery B may be, for example, a capacitor.

The power circuit 7 includes a power line connecting the fuel cell stack 2 to the drive motor M, the battery B, and the like, a DC/DC converter provided on the power line to step up and down DC power output from the fuel cell stack 2, and an inverter provided on the power line to convert DC power output from the DC/DC converter into three-phase AC power and supply the AC power to the drive motor M or convert three-phase AC power supplied from the drive motor M into DC power and supply the DC power to the battery B. A plurality of switching elements constituting the DC/DC converter and the inverter are turned on/off in response to a gate driving signal generated at a predetermined timing from the gate drive circuit (not shown) of the ECU 6. Thus, the ECU 6 can control the flow of power among the fuel cell stack 2, the battery B, and the drive motor M in the power circuit 7 by operating the DC/DC converter and the inverter by using the gate drive circuit.

The ECU 6 is a computer having a plurality of functions such as a required output acquisition function, a power generation control function, a temperature control function, an output control function, and a stack protection control function. The required output acquisition function refers to a function that allows the ECU 6 to acquire a required output corresponding to a request for output from the fuel cell stack 2 on the basis of the amount of operation of the accelerator pedal or the brake pedal (not shown) by the driver.

The power generation control function refers to a function that allows the ECU 6 to control the power generation state of the fuel cell stack 2 by operating the anode gas supplier 3 or the cathode gas supplier 4 on the basis of the required output. The temperature control function refers to a function that allows the ECU 6 to control the temperature of the fuel cell stack 2 by operating the cooling system 5. The output control function refers to a function that allows the ECU 6 to control the output of the fuel cell stack 2 to satisfy the required output by operating the DC/DC converter or the inverter of the power circuit 7 on the basis of the required output.

The stack protection control function refers to a function that allows the ECU 6 to periodically start during soak of the fuel cell stack 2 by using an integrated real time clock (RTC) and perform processing for protecting the fuel cell stack 2 during soak as necessary, the processing including a drying process, a power generation shutdown process, an anode gas filling process, and a fuel supply process, described later.

The ECU 6 is connected to a plurality of sensors for keeping track of the state of the fuel cell stack 2 during power generation, the sensors including a cell voltage sensor 24, a current sensor 26, a cathode pressure sensor 27, an anode pressure sensor 28, a medium pressure sensor 25, and an upstream pressure sensor 29.

The cell voltage sensor 24 detects the voltage (so-called cell voltage) of each fuel battery cell constituting the fuel cell stack 2 and transmits a signal approximately proportional to the detected value to the ECU 6. The current sensor 26 detects the output current of the fuel cell stack 2, more specifically, a current output from the fuel cell stack 2 to loads such as the drive motor M and the battery B via the power circuit 7 and transmits a signal approximately proportional to the detected value to the ECU 6.

For example, the cathode pressure sensor 27 is provided between the inlet seal valve 421 and the fuel cell stack 2 on the air supply pipe 42. The cathode pressure sensor 27 detects the pressure of cathode gas between the inlet seal valve 421 and the fuel cell stack 2 on the air supply pipe 42 and transmits a signal approximately proportional to the detected value to the ECU 6. The ECU 6 acquires, as a cathode pressure, a pressure detected by the cathode pressure sensor 27 provided at the position.

The hydrogen supply pipe 32 includes the upstream pressure sensor 29, the medium pressure sensor 25, and the anode pressure sensor 28 in this order from the hydrogen tank 31 on the high-pressure side to the fuel cell stack 2 on the low-pressure side.

For example, the upstream pressure sensor 29 is provided between the hydrogen tank 31 and the pressure reducing valve 324 on the hydrogen supply pipe 32. The upstream pressure sensor 29 detects the pressure of anode gas between the hydrogen tank 31 and the pressure reducing valve 324 on the hydrogen supply pipe 32 and transmits a signal approximately proportional to the detected value to the ECU 6. The ECU 6 acquires, as an upstream pressure, a pressure detected by the upstream pressure sensor 29 provided at the position.

For example, the medium pressure sensor 25 is provided between the shutoff valve 321 and the injector 322 on the hydrogen supply pipe 32. The medium pressure sensor 25 detects the pressure of anode gas between the shutoff valve 321 and the injector 322 on the hydrogen supply pipe 32 and transmits a signal approximately proportional to the detected value to the ECU 6. The ECU 6 acquires, as a medium pressure, the pressure detected by the medium pressure sensor 25 provided at the position.

For example, the anode pressure sensor 28 is provided between the injector 322 and the fuel cell stack 2 on the hydrogen supply pipe 32. The anode pressure sensor 28 detects the pressure of anode gas between the injector 322 and the fuel cell stack 2 on the hydrogen supply pipe 32 and transmits a signal approximately proportional to the detected value to the ECU 6. The ECU 6 acquires, as an anode pressure, a pressure detected by the anode pressure sensor 28 provided at the position.

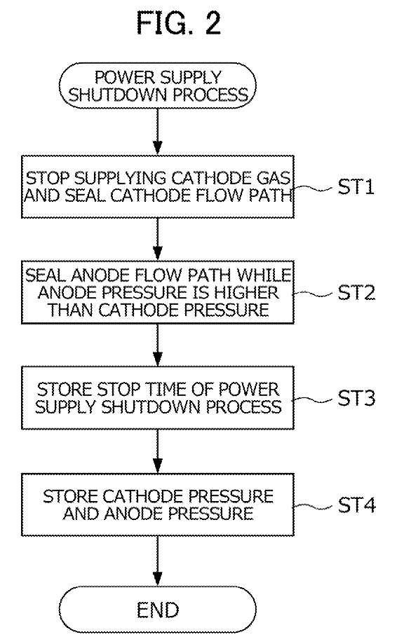

FIG. 2 is a flowchart showing the specific steps of a power generation shutdown process. In order to suppress deterioration of the fuel cell stack 2 during soak and at the time of restart, the power generation shutdown process is performed by the ECU 6 when the power generation of the fuel cell stack 2 is stopped. In this case, the power generation of the fuel cell stack 2 is stopped immediately after power generation by the fuel cell stack 2 is terminated. More specifically, the ECU 6 performs the power generation shutdown process in FIG. 2, for example, immediately after the termination of power generation by the fuel cell stack 2 for generating power for driving a vehicle or immediately after the termination of power generation by the fuel cell stack 2 in a drying process performed appropriately during soak of the fuel cell stack 2. The drying process refers to the process of heating and drying the inside of the fuel cell stack 2. The drying process is appropriately performed by the ECU 6 during soak of the fuel cell stack 2.

When power generation by the fuel cell stack 2 is terminated, first in step ST1, the ECU 6 stops the supply of cathode gas and seals the cathode flow path 22 of the fuel cell stack 2 and then shifts to step ST2. More specifically, the ECU 6 stops the air compressor 41 to stop supplying cathode gas and closes the inlet seal valve 421 and the outlet seal valve 431. Thus, the inlet side and the outlet side of the cathode flow path 22 of the fuel cell stack 2 are sealed and are isolated from the outside air.

Next, in step ST2, the ECU 6 seals the anode flow path 21 of the fuel cell stack 2 in a state in which the anode pressure is higher than the cathode pressure, and then the ECU 6 shifts to step ST3. More specifically, the ECU 6 supplies anode gas to the anode flow path 21 of the fuel cell stack 2 by driving the injector 322 with the opened shutoff valve 321 and the opened tank valve 311 until the anode pressure reaches a predetermined target pressure higher than the cathode pressure. Thereafter, the ECU 6 closes the shutoff valve 321 and the tank valve 311 when the anode pressure reaches the target pressure, and then the ECU 6 stops driving the injector 322 to stop supplying anode gas to the fuel cell stack 2, and closes the purge valve 332. Thus, the inlet side and the outlet side of the anode flow path 21 of the fuel cell stack 2 are sealed in a state in which the anode pressure is higher than the cathode pressure.

Next, in step ST3, the ECU 6 stores the current time as the stop time of the power generation shutdown process, and then shifts to step ST4. In step ST4, the ECU 6 stores the cathode pressure and the anode pressure at the present time, that is, upon completion of the power generation shutdown process, and then terminates the power generation shutdown process shown in FIG. 2.

In the power generation shutdown process, the ECU 6 operates the anode gas supplier 3 and the cathode gas supplier 4 according to the above-described steps, so that the anode flow path 21 and the cathode flow path 22 are sealed in a state in which the anode pressure is higher than the cathode pressure. This can suppress the permeation of oxygen from the cathode electrode to the anode electrode in the fuel cell stack 2 during soak, thereby reducing the deterioration of the fuel cell stack 2, the deterioration being caused by an increase in cathode potential during soak.

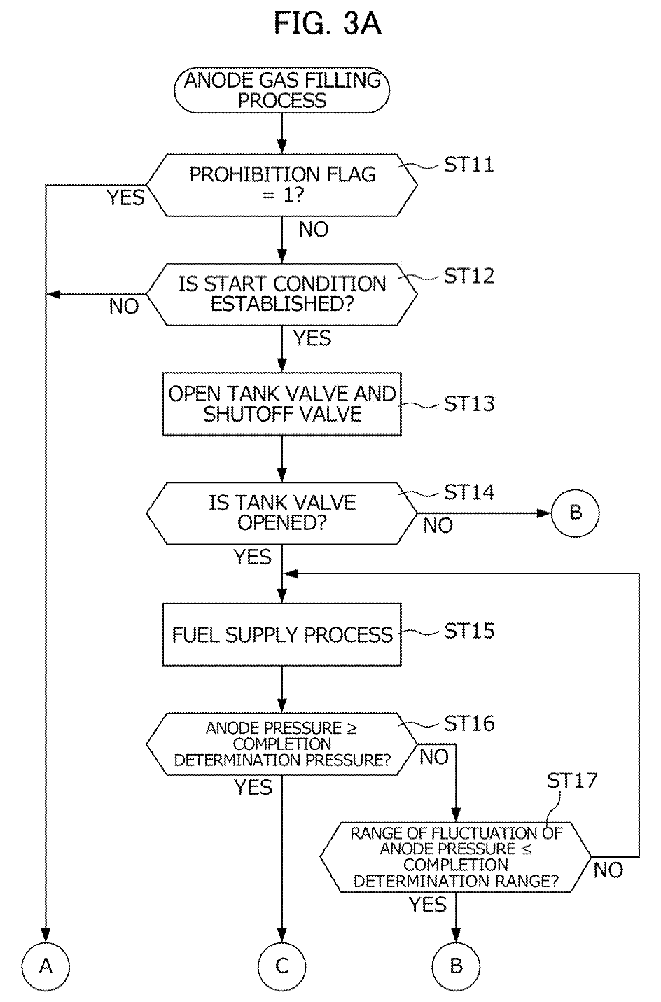

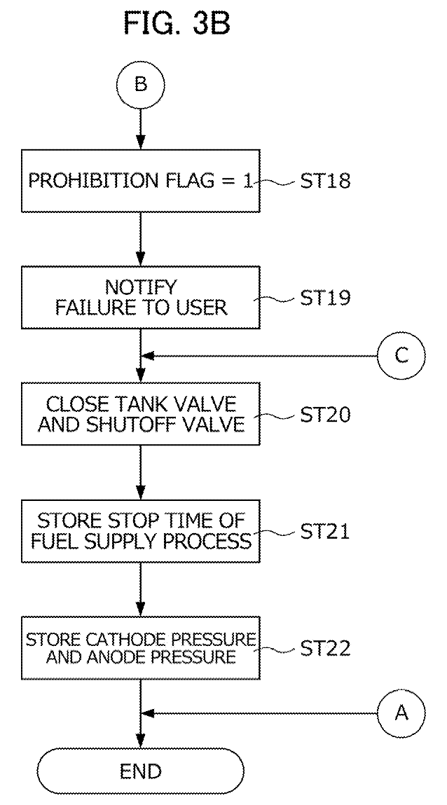

FIGS. 3A and 3B are flowcharts showing the specific steps of the anode gas filling process. As described above, in order to suppress the deterioration of the fuel cell stack 2, the deterioration being caused by an increase in cathode potential during soak, the anode pressure of the fuel cell stack 2 needs to be kept high during soak after the power generation shutdown process is completed. The anode gas filling process is performed by the ECU 6 during soak of the fuel cell stack 2 in order to keep the anode pressure of the fuel cell stack 2 high during soak. The anode gas filling process shown in FIG. 3 is periodically performed by the ECU 6 during soak of the fuel cell stack 2 after the completion of the power generation shutdown process shown in FIG. 2. More specifically, after the completion of the power generation shutdown process, the ECU 6 starts the anode gas filling process shown in FIGS. 3A and 3B when being automatically started by the integrated RTC during soak of the fuel cell stack 2.

First, in step ST11, the ECU 6 determines whether the value of a prohibition flag, which will be described later, is "1" or not. In this case, the prohibition flag is a flag indicating a state in which the execution of the fuel supply process (see step ST15 described later) is prohibited. The fuel supply process will be described later. When the determination result of step ST11 is NO, the ECU 6 shifts to step ST12. When the determination result is YES, the anode gas filling process shown in FIGS. 3A and 3B is completed without performing the processing of steps ST12 to ST22.

Next, in step ST12, the ECU 6 determines whether a predetermined start condition for starting the fuel supply process has been established or not. When the determination result of step ST12 is YES, that is, when the start condition is satisfied, the ECU 6 shifts to step ST13. When the determination result is NO, that is, when the start condition is not satisfied, the ECU 6 completes the anode gas filling process shown in FIGS. 3A and 3B.

In the following description, the ECU 6 starts the fuel supply process on the start condition that a predetermined set time has elapsed from the later of the end time (see step ST3 described above) of the power generation shutdown process or the end time (see step ST21 described below) of the previous fuel supply process, but the present invention is not limited thereto. For example, the set time may be set in advance or may be set on the basis of the cathode pressure and the anode pressure (see step ST4 described above or step ST22 described later) upon completion of the power generation shutdown process or the previous fuel supply process. Alternatively, the ECU 6 may start the fuel supply process on the start condition that the current anode pressure is reduced by a predetermined pressure from the anode pressure serving as a reference pressure upon completion of the power generation shutdown process or the previous fuel supply process.

Next, in step ST13, the ECU 6 first opens the tank valve 311 and the shutoff valve 321 when the start condition is satisfied, and then the ECU 6 shifts to step ST14. Thus, the upstream side is filled with high-pressure anode gas by the injector 322 on the hydrogen supply pipe 32.

Next, in step ST14, the ECU 6 determines whether the tank valve 311 has been opened or not. More specifically, the ECU 6 determines whether the tank valve 311 has been opened or not by referring to, for example, a signal transmitted from a tank valve sensor (not shown) provided in the hydrogen tank 31. When the determination result of step ST14 is YES, the ECU 6 shifts to step ST15. When the determination result of step ST14 is NO, the ECU 6 determines that the tank valve 311 is in failure and then shifts to step ST18.

In step ST15, the ECU 6 performs the fuel supply process for supplying anode gas to the anode flow path 21 of the fuel cell stack 2 during soak, and then the ECU 6 shifts to step ST16. More specifically, in a state in which the tank valve 311 and the shutoff valve 321 are opened, the ECU 6 drives the injector 322 and supplies anode gas supplied from the hydrogen tank 31, to the anode flow path 21 of the fuel cell stack 2 as described above. Thus, the anode pressure increases.

In step ST16, the ECU 6 determines whether the anode pressure has reached a completion determination pressure that is set higher than at least the current cathode pressure. The completion determination pressure may be set in advance or may be set on the basis of the current cathode pressure. When the determination result of step ST16 is YES, that is, when the anode pressure is raised to the completion determination pressure by performing the fuel supply process, the ECU 6 terminates the fuel supply process by stopping driving the injector 322, and then shifts to step ST20. When the determination result of step ST16 is NO, the ECU 6 shifts to step ST17.

In step ST17, the ECU 6 determines whether or not the range of fluctuation of the anode pressure over a predetermined time is equal to or smaller than a predetermined completion determination range after the start of the fuel supply process in step ST15. When the determination result of step ST17 is NO, that is, when the anode pressure has not reached the completion determination pressure and the range of fluctuation of the anode pressure over the predetermined time is equal to or smaller than the completion determination range, the ECU 6 returns to step ST15 to continue the fuel supply process. As described above, if the above-described start condition is satisfied after the completion of the power generation shutdown process, the ECU 6 performs the fuel supply process until the anode pressure reaches the completion determination pressure.

When the determination result of step ST17 is YES, that is, when the range of fluctuation of the anode pressure over the predetermined time is equal to or smaller than the completion determination range, it is assumed that the anode pressure is hardly changed even by opening the injector 322. In addition, it is assumed that the remaining amount of anode gas in the hydrogen tank 31 has decreased until a pressure on the upstream side of the injector 322 (that is, a medium pressure detected by the medium pressure sensor 25) and a pressure on the downstream side of the injector 322 (that is, an anode pressure detected by the anode pressure sensor 28) are nearly equal to each other. Thus, when the determination result of step ST17 is YES, the ECU 6 terminates the fuel supply process by stopping driving the injector 322 even when the anode pressure is lower than the completion determination pressure, and then the ECU 6 shifts to step ST18.

In step ST18, the ECU 6 sets the value of the prohibition flag to "1" to prohibit the subsequent fuel supply process, and then the ECU 6 shifts to step ST19. That is, when the tank valve 311 is in failure (see step ST14 described above) or when the remaining amount of anode gas is insufficient until a pressure on the upstream side of the injector 322 and a pressure on the downstream side of the injector 322 are nearly equal to each other (see step ST17 described above), the appropriate fuel supply process cannot be performed. Thus, the ECU 6 sets the value of the prohibition flag to "1". The value of the prohibition flag is reset to "0" when the cause of hindrance to the execution of the appropriate fuel supply process is removed, that is, when the repair of the tank valve 311 is completed or when the hydrogen tank 31 is sufficiently filled with anode gas.

In step ST19, the ECU 6 notifies a user about the occurrence of a failure that may interfere with the execution of the appropriate fuel supply process, and then the ECU 6 shifts to step ST20. More specifically, when the tank valve 311 is in failure (that is, when the determination result of step ST14 described above is NO), the ECU 6 turns on a predetermined warning lamp to notify the user that the tank valve 311 is in failure. Furthermore, when the remaining amount of anode gas in the hydrogen tank 31 is insufficient (that is, when the determination result of step ST17 described above is YES), the ECU 6 turns on the predetermined warning lamp to notify the user that the remaining amount of anode gas is insufficient.

In step ST20, the ECU 6 seals the anode flow path 21 by closing the tank valve 311 and the shutoff valve 321, and then shifts to step ST21. In step ST21, the ECU 6 stores the current time as the stop time of the fuel supply process, and then shifts to step ST22. In step ST22, the ECU 6 stores a cathode pressure and an anode pressure at the present time, that is, at the completion of the fuel supply process, and then completes the anode gas filling process shown in FIGS. 3A and 3B.

In the anode gas filling process and the fuel supply process, the ECU 6 operates the anode gas supplier 3 according to the above-described steps, so that the anode flow path 21 is filled with anode gas during soak of the fuel cell stack 2. Therefore, the anode pressure of the fuel cell stack 2 can be kept high during soak, thereby suppressing deterioration of the fuel cell stack 2.

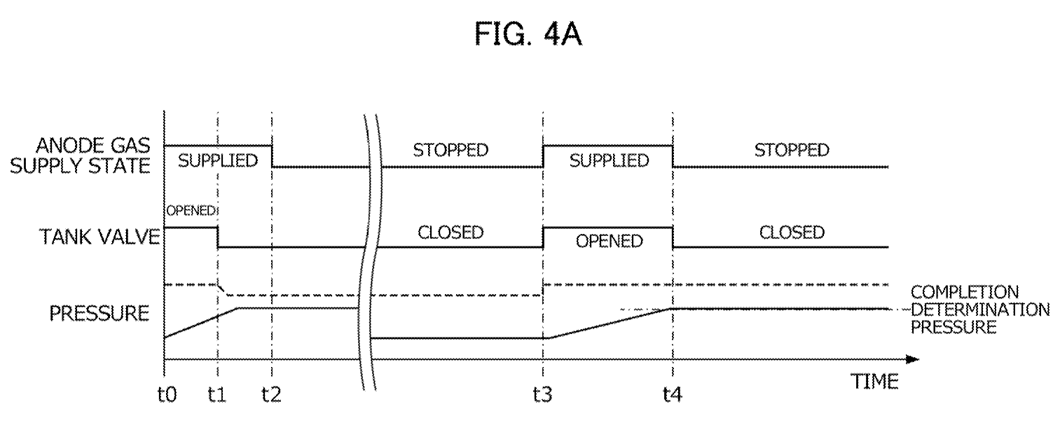

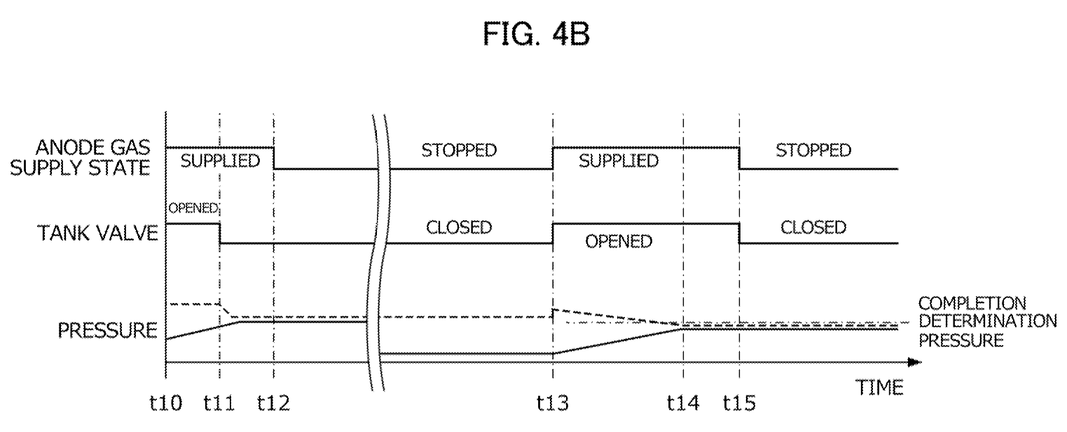

FIG. 4A is a time chart showing a first example of a change of an anode pressure, the change being made by the power generation shutdown process (see FIG. 2) and the anode gas filling process (see FIGS. 3A and 3B). In the lower part of FIG. 4A, the solid line indicates an anode pressure (that is, a pressure detected on the downstream side of the injector 322 by the anode pressure sensor 28), and the dashed line indicates a medium pressure (that is, a pressure detected on the upstream side of the injector 322 by the medium pressure sensor 25).

First, at time t0, the ECU 6 starts the power generation shutdown process shown in FIG. 2 at the completion of power generation by the fuel cell stack 2. As described above, first at time t0, the ECU 6 stops supplying cathode gas and closes the cathode flow path 22. Furthermore, after closing the cathode flow path 22 at time t0, the ECU 6 continues to supply anode gas until the anode pressure reaches a target pressure set higher than the cathode pressure. Thus, as shown in FIG. 4A, the anode pressure keeps rising after time t0.

Thereafter, the ECU 6 closes the shutoff valve 321 and the tank valve 311 when the anode pressure reaches the target pressure at time t1. Thus, as shown in FIG. 4A, the anode pressure increases and the medium pressure decreases after time t1. The ECU 6 then stops supplying anode gas by stopping driving the injector 322 at time t2, and closes the purge valve 332. Thus, at time t2, the anode flow path 21 of the fuel cell stack 2 is sealed in a state in which the anode pressure is higher than the cathode pressure. Furthermore, the ECU 6 stores time t2, at which the anode flow path 21 is sealed, as the stop time of the power generation shutdown process.

FIG. 4A shows that the shutoff valve 321 and the tank valve 311 are closed at time t1, and the driving of the injector 322 is stopped and the purge valve 332 is closed at time t2. The present invention is not limited to this case. If the anode flow path 21 of the fuel cell stack 2 can be sealed in a state in which the anode pressure is higher than the cathode pressure, the shutoff valve 321, the tank valve 311, and the purge valve 332 may be closed and the driving of the injector 322 may be stopped in any desired order.

In the power generation shutdown process, the ECU 6 operates the anode gas supplier 3 and the cathode gas supplier 4 according to the above-described steps, so that the anode flow path 21 and the cathode flow path 22 are sealed in a state in which the anode pressure is higher than the cathode pressure. However, if the soak period of the fuel cell stack 2 is extended, hydrogen filling the anode flow path passes through the cathode flow path and is consumed by a reaction with oxygen, so that the anode pressure gradually decreases as shown in FIG. 4A.

The ECU 6 then starts the fuel supply process (see step ST15 of FIG. 3A) when the start condition (see step ST12 of FIG. 3A) is satisfied at time t3. More specifically, the ECU 6 starts the fuel supply process at time t3 when a set time has elapsed from the end time t2 of the power generation shutdown process. More specifically, the ECU 6 opens the shutoff valve 321 and the tank valve 311 at time t3 (see step ST13 of FIG. 3A), confirms the tank valve 311 in an opened state (see step ST14 of FIG. 3A), and then starts driving the injector 322 (see step ST15 of FIG. 3A). Thus, as shown in FIG. 4A, the anode pressure starts rising.

After the fuel supply process is started according to the above-described steps, the ECU 6 terminates the fuel supply process by stopping driving the injector 322 when the anode pressure reaches, at time t4, the completion determination pressure indicated by a dash-dot line in FIG. 4A (see step ST16 of FIG. 3A). The ECU 6 then closes the shutoff valve 321 and the tank valve 311 (see step ST20 of FIG. 3B). Thus, the anode pressure is kept high, thereby reducing the deterioration of the fuel cell stack 2, the deterioration being caused by an increase in cathode potential during soak. Furthermore, the ECU 6 stores time t4 as the stop time of the fuel supply process (see step ST21 of FIG. 3B). Therefore, if the soak period of the fuel cell stack 2 is further extended, the ECU 6 performs the fuel supply process again when a set time has elapsed from the end time t4 of the fuel supply process. Thus, the anode pressure is kept high even if the soak period is extended.

FIG. 4B is a time chart showing a second example of a change of an anode pressure, the change being made by the power generation shutdown process (see FIG. 2) and the anode gas filling process (see FIGS. 3A and 3B) described above. FIG. 4B shows a case in which the remaining amount of anode gas in the hydrogen tank 31 is smaller than that of the example of FIG. 4A. Since an event that occurs between times t10 and t13 in the example shown in FIG. 4B is qualitatively identical to an event that occurs between times t0 and t3 in the example shown in FIG. 4A, and thus the detailed description thereof is omitted.

The ECU 6 starts the fuel supply process (see step ST15 of FIG. 3A) when the start condition (see step ST12 of FIG. 3A) is satisfied at time t13. More specifically, the ECU 6 starts the fuel supply process at time t13 when a set time has elapsed from the end time t12 of the power generation shutdown process. Still more specifically, the ECU 6 opens the shutoff valve 321 and the tank valve 311 at time t13 (see step ST13 of FIG. 3A), confirms the tank valve 311 in an opened state (see step ST14 of FIG. 3A), and then starts driving the injector 322 (see step ST15 of FIG. 3A).

As described above, in the example shown in FIG. 4B, the remaining amount of anode gas in the hydrogen tank 31 is smaller than that of the example shown in FIG. 4A. Thus, by starting the fuel supply process at time t13, the anode pressure starts rising, but the rate of rise is lower than that of the example of FIG. 4A. In addition, since the remaining amount of anode gas in the hydrogen tank 31 is small, the medium pressure decreases as the anode pressure increases. Thus, the anode pressure becomes approximately constant after rising almost to the medium pressure at time t14. In other words, after time t14, a pressure difference between the upstream side and the downstream side of the injector 322 is approximately 0, so that the anode pressure becomes approximately constant before reaching the completion determination pressure. Thereafter, at time t15, when it is determined that the range of fluctuation of the anode pressure over the predetermined time is equal to or smaller than the completion determination range, the ECU 6 terminates the fuel supply process by stopping driving the injector 322 even when the anode pressure is lower than the completion determination pressure (see step ST17 of FIG. 3A). The ECU 6 then closes the shutoff valve 321 and the tank valve 311 (see step ST20 of FIG. 3B). Furthermore, at time t15, the ECU 6 sets the value of the prohibition flag to "1" (see step ST18 of FIG. 3B) to prohibit the subsequent fuel supply process, and then notifies the user that the remaining amount of anode gas is insufficient.

The fuel cell system 1 according to the present embodiment has the following effects:
(1) When stopping the power generation of the fuel cell stack 2, the ECU 6 performs the power generation shutdown process in which the inlet seal valve 421 and the outlet seal valve 431 are closed, and then the supply of anode gas to the fuel cell stack 2 is stopped and the purge valve 332 is closed while the anode pressure of the fuel cell stack 2 is higher than the cathode pressure. Furthermore, if the predetermined start condition is satisfied after the completion of the power generation shutdown process, the ECU 6 performs the fuel supply process in which anode gas is supplied to the fuel cell stack 2 until the anode pressure reaches the predetermined completion determination pressure. Thus, the hydrogen partial pressure in the anode electrode of the fuel cell stack 2 during soak can be kept at a predetermined pressure or higher, thereby reducing the deterioration of the fuel cell stack 2, the deterioration being caused by an increase in cathode potential during soak of the fuel cell stack 2. After the fuel supply process is started, when the range of fluctuation of the anode pressure over the predetermined time is equal to or smaller than the predetermined completion determination range, the ECU 6 terminates the ongoing fuel supply process even if the anode pressure is lower than the completion determination pressure. Thus, according to the fuel cell system 1, even if the remaining amount of anode gas is insufficient at the start of the fuel supply process as described above, the remaining anode gas can be supplied to the fuel cell stack 2 as much as possible. This can minimize deterioration of the fuel cell as much as possible and contribute to higher energy efficiency, the deterioration being caused by an increase in cathode potential during soak.
(2) The ECU 6 acquires, as an anode pressure, a pressure detected by the anode pressure sensor 28 provided on the fuel cell stack 2 side relative to the injector 322 on the hydrogen supply pipe 32 connecting the hydrogen tank 31 and the inlet side of the anode flow path 21. As described above, in the fuel cell system 1, the timing for terminating the fuel supply process is determined on the basis of the range of fluctuation of a pressure on the low-pressure side of the injector 322 on the hydrogen supply pipe 32 reaching the fuel cell stack 2 on the low-pressure side from the hydrogen tank 31 on the high-pressure side. Thus, even when the remaining amount of anode gas is insufficient in the hydrogen tank 31, the remaining anode gas is supplied to the fuel cell stack 2 as much as possible, thereby minimizing the deterioration of the fuel cell stack 2 as much as possible.
(3) Furthermore, if the fuel supply process is terminated before the anode pressure reaches the completion determination pressure, in other words, if the fuel supply process is terminated because the remaining amount of anode gas is insufficient in the hydrogen tank 31, the ECU 6 prohibits the subsequent fuel supply process and notifies the user that the remaining amount of anode gas is insufficient in the hydrogen tank 31. Thus, for the subsequent start of the fuel cell system 1, the consumption of anode gas can be minimized in the fuel cell stack 2 during soak as much as possible, and the user can recognize that the remaining amount of anode gas is insufficient.
(4) The ECU 6 starts the fuel supply process on the start condition that a set time has elapsed from the completion of the power generation shutdown process. In other words, when a set time has elapsed from the completion of the power generation shutdown process, the ECU 6 starts the fuel supply process regardless of the remaining amount of anode gas at that time. Thus, according to the fuel cell system 1, anode gas can be supplied to the fuel cell stack 2 as much as possible even if the remaining amount of anode gas is insufficient, thereby minimizing the deterioration of the fuel cell stack 2 as much as possible, the deterioration being caused by an increase in cathode potential during soak.
(5) The ECU 6 starts the fuel supply process on the start condition that the anode pressure is reduced by a predetermined pressure from the completion of the power generation shutdown process. In other words, if the anode pressure is reduced by the predetermined pressure from the completion of the power generation shutdown process, the ECU 6 starts the fuel supply process regardless of the remaining amount of anode gas at that time. Thus, according to the fuel cell system 1, anode gas can be supplied to the fuel cell stack 2 as much as possible even if the remaining amount of anode gas is insufficient, thereby minimizing the deterioration of the fuel cell stack 2 as much as possible, the deterioration being caused by an increase in cathode potential during soak.

### Second Embodiment

Next, a fuel cell system according to a second embodiment of the present invention will be described below with reference to the accompanying drawings. The fuel cell system according to the present embodiment is different from the above-described fuel cell system 1 according to the first embodiment in the steps of an anode gas filling process. More specifically, the fuel cell system according to the present embodiment is different from the fuel cell system 1 according to the first embodiment in the flow before a fuel supply process is started in the anode gas filling process.

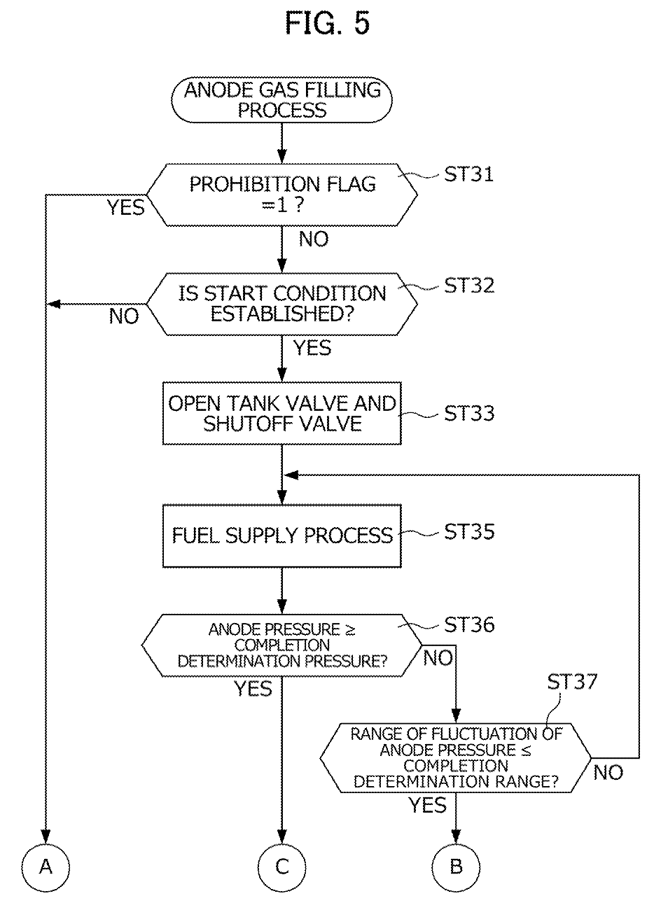

FIG. 5 is a part of a flowchart showing the specific steps of the anode gas filling process in the fuel cell system according to the present embodiment. The continuation of the processing of FIG. 5 is the same as that of FIG. 3B, and thus the illustration and detailed description thereof are omitted. The processing of steps ST31 to ST33 and steps ST35 to ST37 of FIG. 5 is the same as the processing of steps ST11 to ST13 and steps ST15 to ST17 of FIG. 3A, and thus the detailed description thereof is omitted. That is, the anode gas filling process according to the present embodiment is different only in that the process does not include the anode gas filling process shown in FIGS. 3A and 3B and the process for determining whether a tank valve 311 is opened or not (see step ST14 of FIG. 3A). That is, in the anode gas filling process according to the present embodiment, when the start condition is established in step ST32, the fuel supply process is started without confirming whether the tank valve 311 is opened or not (see step ST35).

The fuel cell system according to the present embodiment has the following effects:

(6) Thus, on the upstream side of an injector 322 on a hydrogen supply pipe 32, a small amount of anode gas is present with a higher pressure than the downstream side of the injector 322 before the tank valve 311 is opened (for example, see times t2 to t3 of FIG. 4A and times t12 to t13 of FIG. 4B). Thus, even if the tank valve 311 is in failure and cannot be opened, part of high-pressure anode gas on the upstream side of the injector 322 on the hydrogen supply pipe 32 can be supplied to the fuel cell stack 2 by opening a shutoff valve 321 and driving the injector 322, thereby slightly suppressing the deterioration of a fuel cell stack 2.

### Third Embodiment

Next, a fuel cell system according to a third embodiment of the present invention will be described below with reference to the accompanying drawings. The fuel cell system according to the present embodiment is different from the above-described fuel cell system 1 according to the first embodiment in the steps of an anode gas filling process. More specifically, the fuel cell system according to the present embodiment is different from the fuel cell system 1 according to the first embodiment in the steps of the anode gas filling process.

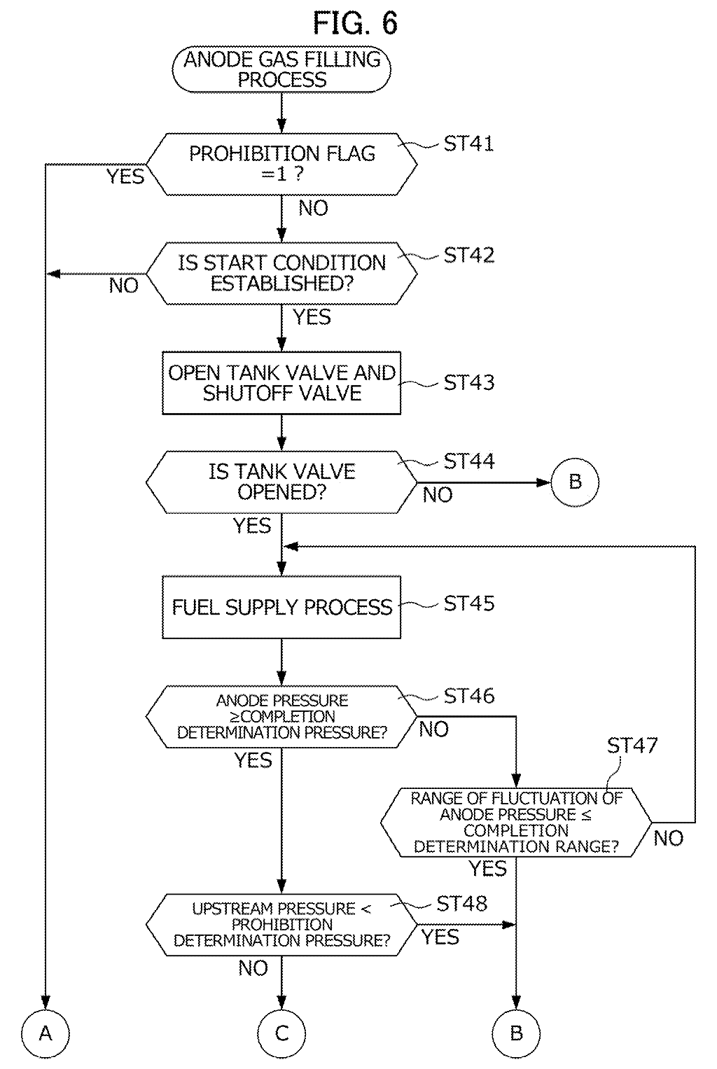

FIG. 6 is a part of a flowchart showing the specific steps of the anode gas filling process in the fuel cell system according to the present embodiment. The continuation of the processing of FIG. 6 is the same as that of FIG. 3B, and thus the illustration and detailed description thereof are omitted. The processing of steps ST41 to ST47 of FIG. 6 is the same as the processing of steps ST11 to ST17 of FIG. 3A, and thus the detailed description thereof is omitted.

When it is determined that the anode pressure has reached a completion determination pressure in step ST46, an ECU 6 terminates a fuel supply process by stopping driving an injector 322, and then the ECU 6 shifts to step ST48. In step ST48, the ECU 6 determines whether an upstream pressure detected by an upstream pressure sensor 29 provided between a hydrogen tank 31 and a pressure reducing valve 324 on a hydrogen supply pipe 32 is lower than a prohibition determination pressure that indicates that the remaining amount is insufficient in the hydrogen tank 31. When the determination result of step ST48 is NO, the ECU 6 shifts to step ST20 of FIG. 3B. When the determination result of step ST48 is YES, that is, when the upstream pressure is lower than the prohibition determination pressure at the completion of the fuel supply process, the ECU 6 shifts to step ST18 of FIG. 3B to prohibit the subsequent fuel supply process.

The fuel cell system according to the present embodiment has the following effects:

(7) At the completion of the fuel supply process, the ECU 6 prohibits the execution of the subsequent fuel supply process when the upstream pressure detected by the upstream pressure sensor 29 provided between the hydrogen tank 31 and the pressure reducing valve 324 on the hydrogen supply pipe 32 is lower than the predetermined prohibition determination pressure. This can prevent an excessive reduction in pressure in the hydrogen tank 31 during soak, thereby protecting the hydrogen tank 31.

### Fourth Embodiment

Next, a fuel cell system according to a fourth embodiment of the present invention will be described below with reference to the accompanying drawings. The fuel cell system according to the present embodiment is different from the fuel cell system 1 according to the first embodiment in the steps of an anode gas filling process. More specifically, the fuel cell system according to the present embodiment is different from the fuel cell system according to the third embodiment in the flow before a fuel supply process is started in the anode gas filling process.

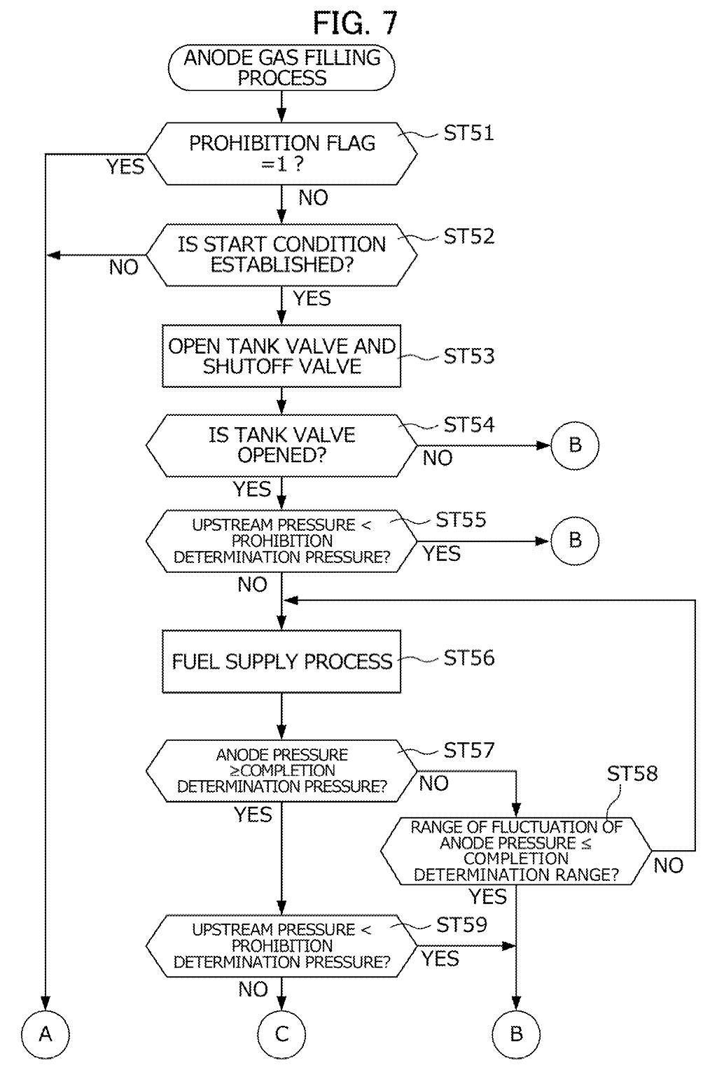

FIG. 7 is a part of a flowchart showing the specific steps of the anode gas filling process in the fuel cell system according to the present embodiment. The continuation of the processing of FIG. 7 is the same as that of FIG. 3B, and thus the illustration and detailed description thereof are omitted. Furthermore, the processing of steps ST51 to ST54 and steps ST56 to ST59 of FIG. 7 is the same as the processing of steps ST41 to ST44 and steps ST45 to ST48 of FIG. 6, and thus the detailed description thereof is omitted.

In step ST54, an ECU 6 confirms that a tank valve 311 is opened, and then in step ST55, the ECU 6 determines whether an upstream pressure detected by an upstream pressure sensor 29 is lower than a prohibition determination pressure. When the determination result of step ST55 is NO, the ECU 6 shifts to step ST56 to start the fuel supply process. When the determination result of step ST55 is YES, that is, when the upstream pressure is lower than the prohibition determination pressure after the tank valve 311 is opened, the ECU 6 shifts to step ST18 of FIG. 3B to prohibit the current and subsequent fuel supply processes.

The fuel cell system according to the present embodiment has the following effects:

(8) When the upstream pressure is lower than the prohibition determination pressure immediately before the fuel supply process is started, more specifically, after the tank valve 311 is opened, the ECU 6 prohibits the current and subsequent fuel supply processes. This can prevent an excessive reduction in pressure in a hydrogen tank 31 during soak, thereby protecting the hydrogen tank 31.

The embodiment of the present invention has been described but does not limit the present invention. The detailed configuration can be changed as appropriate within the scope of the gist of the present invention.

What is claimed is:

1. A fuel cell system comprising a fuel cell that generates power when receiving anode gas and cathode gas, the fuel cell system comprising:
a cathode gas supplier that supplies cathode gas to a cathode flow path of the fuel cell;
an anode gas supplier that supplies anode gas to an anode flow path of the fuel cell; and
a controller that operates the cathode gas supplier and the anode gas supplier,
the cathode gas supplier including cathode seal valves provided on an inlet side and an outlet side of the cathode flow path,
the anode gas supplier including an anode discharge valve provided on an outlet side of the anode flow path,
the controller being configured to perform
a shutdown process for closing the cathode seal valves at a power generation shutdown of the fuel cell, and then stopping supply of anode gas to the fuel cell and closing the anode discharge valve in a state in which the fuel cell has an anode pressure higher than a cathode pressure, and
a fuel supply process for supplying, when a predetermined start condition is satisfied after completion of the shutdown process, anode gas to the fuel cell until the anode pressure reaches a predetermined completion determination pressure,
the controller terminating the fuel supply process even if the anode pressure is lower than the completion determination pressure when a range of fluctuation of the anode pressure over a predetermined time is equal to or smaller than a predetermined completion determination range after start of the fuel supply process.

2. The fuel cell system according to claim 1, wherein the anode gas supplier includes: an anode gas supply source, an anode gas supply path connecting the anode gas supply source and an inlet side of the anode flow path, an injector provided on the anode gas supply path, and an anode gas return path connecting the outlet side of the anode flow path and a downstream side of the injector on the anode gas supply path, and
the controller acquires, as the anode pressure, a pressure detected by a first pressure detector provided between the injector and the fuel cell on the anode gas supply path.

3. The fuel cell system according to claim 2, wherein when the fuel supply process is terminated before the anode pressure reaches the completion determination pressure, the controller prohibits a subsequent fuel supply process and notifies a user that a remaining amount of anode gas is insufficient in the anode gas supply source.

4. The fuel cell system according to claim 1, wherein the controller starts the fuel supply process on the start condition that a predetermined time has elapsed from the completion of the shutdown process.

5. The fuel cell system according to claim 1, wherein the controller starts the fuel supply process on the start condition that the anode pressure is reduced by a predetermined pressure from the completion of the shutdown process.

6. The fuel cell system according to claim 2, wherein the controller starts the fuel supply process on the start condition that a predetermined time has elapsed from the completion of the shutdown process.

7. The fuel cell system according to claim 2, wherein the controller starts the fuel supply process on the start condition that the anode pressure is reduced by a predetermined pressure from the completion of the shutdown process.

8. The fuel cell system according to claim 3, wherein the controller starts the fuel supply process on the start condition that a predetermined time has elapsed from the completion of the shutdown process.

9. The fuel cell system according to claim 3, wherein the controller starts the fuel supply process on the start condition that the anode pressure is reduced by a predetermined pressure from the completion of the shutdown process.

10. The fuel cell system according to claim 2, wherein the anode gas supplier further includes a pressure reducing valve provided between the injector and the anode gas supply source on the anode gas supply path, and
at the completion of the fuel supply process, the controller prohibits a subsequent fuel supply process when a pressure detected by a second pressure detector provided between the anode gas supply source and the pressure reducing valve is lower than a predetermined prohibition determination pressure.

11. The fuel cell system according to claim 3, wherein the anode gas supplier further includes a pressure reducing valve provided between the injector and the anode gas supply source on the anode gas supply path, and
at the completion of the fuel supply process, the controller prohibits the subsequent fuel supply process when a pressure detected by a second pressure detector provided between the anode gas supply source and the pressure reducing valve is lower than a predetermined prohibition determination pressure.

12. A control method of a fuel cell system, the fuel cell system comprising a fuel cell that generates power when receiving anode gas and cathode gas; a cathode gas supplier that supplies cathode gas to a cathode flow path of the fuel cell; and an anode gas supplier that supplies anode gas to an anode flow path of the fuel cell,
the cathode gas supplier including cathode seal valves provided on an inlet side and an outlet side of the cathode flow path,
the anode gas suppler including an anode discharge valve provided on an outlet side of the anode flow path,
the control method comprising: a first step of closing the cathode seal valves at a power generation shutdown of the fuel cell, and then stopping supply of anode gas to the fuel cell and closing the anode discharge valve in a state in which the fuel cell has an anode pressure higher than a cathode pressure, and
a second step of supplying, when a predetermined start condition is satisfied after completion of the first step, anode gas to the fuel cell until the anode pressure reaches a predetermined completion determination pressure,
wherein the second step is terminated even if the anode pressure is lower than the completion determination pressure when a range of fluctuation of the anode pressure over a predetermined time is equal to or smaller than a predetermined completion determination range after start of the second step.
